(19) United States
(12) Patent Application Publication
(10) Pub. No.: US 2016/0012957 A1
(43) Pub. Date: Jan. 14, 2016

(54) CHIP COIL COMPONENT

(71) Applicant: SAMSUNG ELECTRO-MECHANICS CO., LTD., Suwon-Si (KR)

(72) Inventor: Bong Sup LIM, Suwon-Si (KR)

(21) Appl. No.: 14/668,830

(22) Filed: Mar. 25, 2015

(30) Foreign Application Priority Data
Jul. 14, 2014 (KR) 10-2014-0088332

(51) Int. Cl. H01F 27/28

(52) U.S. Cl. CPC H01F 27/2804; H01F 2027/2809

(57) ABSTRACT

There is provided a chip coil component including: a ceramic body in which a plurality of ceramic layers are disposed and of which a bottom surface is provided as a mounting surface; a first external electrode disposed on one end surface of the ceramic body in a length direction of the ceramic body and a top surface and the bottom surface of the ceramic body; and a second external electrode disposed on the other end surface of the ceramic body in the length direction of the ceramic body and the bottom surface of the ceramic body.

### CROSS-REFERENCE TO RELATED APPLICATION

This application claims the priority and benefit of Korean Patent Application No. 10-2014-0088332 filed on Jul. 14, 2014 with the Korean Intellectual Property Office, the disclosure of which is incorporated herein by reference.

### BACKGROUND

The present disclosure relates to a chip coil component.

Recently, as the miniaturization and thinning of information technology (IT) devices such as communications devices, display devices, and the like, has been accelerated, research into technology for miniaturizing and thinning various elements such as inductors, capacitors, transistors, and the like, used in such IT devices, has been continuously conducted.

Inductors have also been rapidly replaced by a chip being relatively small with high density, capable of being automatically surface-mounted, and a thin film type inductor, in which a mixture of a magnetic powder and a resin is provided as coil patterns formed by plating the mixture on upper and lower surfaces of a thin film insulating substrate, and a multilayer inductor, in which internal conductors are printed on a magnetic body and a series of processes such as a via hole punching step, a stacking step, a sintering step, and the like is performed, have been continuously developed.

Since multilayer inductors demonstrate predominant reactance components in a low frequency region, such inductors are commonly operated as inductors reflecting noise, but in the case in which the frequency thereof is increased, since the resistance components are increased, such inductors may be operated as resistors converting noise into heat and absorbing the heat generated thereby. Therefore, when a multilayer inductor is operated as a resistor due to an increase in resistance components in a high frequency region, such a multilayer inductor is also known as a multilayer bead.

However, the objective of multilayer inductors is to generate inductance L, but due to the structure of multilayer inductors, self resistance R of internal coil parts, parasitic components C between internal coil patterns, and parasitic components C between the internal coil parts and external electrodes inevitably exist.

### RELATED ART DOCUMENT

(Patent Document 1) Japanese Patent Laid-Open Publication No. 2006-032430

### SUMMARY

An aspect of the present disclosure provides a chip coil component having significantly improved inductance L while an influence of parasitic components C is significantly reduced. The chip coil component according to an exemplary embodiment of the present disclosure may improve Q characteristics and may reduce a loss of magnetic flux.

According to an aspect of the present disclosure, a chip coil component may include: a ceramic body in which a plurality of ceramic layers are disposed and of which a bottom surface is provided as a mounting surface; a first external electrode disposed on one end surface of the ceramic body in a length direction of the ceramic body and a top surface and the bottom surface of the ceramic body; and a second external electrode disposed on the other end surface of the ceramic body in the length direction of the ceramic body and the bottom surface of the ceramic body.

According to another aspect of the present disclosure, a chip coil component may include: a ceramic body in which a plurality of ceramic layers are disposed and of which a bottom surface is provided as a mounting surface; internal coil parts including a plurality of internal coil patterns disposed to be connected to each other on the plurality of ceramic layers within the ceramic body; and first and second external electrodes disposed on both end surfaces of the ceramic body in a length direction of the ceramic body, wherein the plurality of internal coil patterns include first and second lead portions exposed to the end surfaces of the ceramic body in the length direction of the ceramic body and connected to the first and second external electrodes, respectively, a length of a portion of the first external electrode disposed on one end surface of the ceramic body is greater than a distance from the bottom surface of the ceramic body to the first lead portion, and a length of a portion of the second external electrode disposed on the other end surface of the ceramic body is less than a distance from the bottom surface of the ceramic body to the second lead portion.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a chip coil component according to an exemplary embodiment of the present disclosure;

FIG. 2 is a cross-sectional view of the chip coil component shown in FIG. 1 taken along line A-A′;

FIG. 3 is a view showing an inner portion of a ceramic body in the chip coil component shown in FIG. 1;

FIG. 4 is a graph showing changes in Q characteristics depending on an increase in parasitic components in a multilayer inductor according to the related art;

FIG. 5 is a view showing the flow of magnetic flux in the chip coil component according to an exemplary embodiment of the present disclosure;

FIG. 6 is a perspective view of a chip coil component according to another exemplary embodiment of the present disclosure;

FIG. 7 is a view of a marking pattern on the chip coil component shown in FIG. 1;

FIG. 8 is a view illustrating an active part and cover parts of the ceramic body in the chip coil component shown in FIG. 1;

FIG. 9 is a cross-sectional view of the chip coil component shown in FIG. 8; and

FIG. 10 is a graph illustrating comparison results between Q characteristics of a chip coil component according to an exemplary embodiment of the present disclosure and Q characteristics of a multilayer inductor according to the related art.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Chip Coil Component

Hereinafter, a chip coil component 100 according to an exemplary embodiment of the present disclosure, particularly, a multilayer inductor will be described. However, the present inventive concept is not limited thereto.

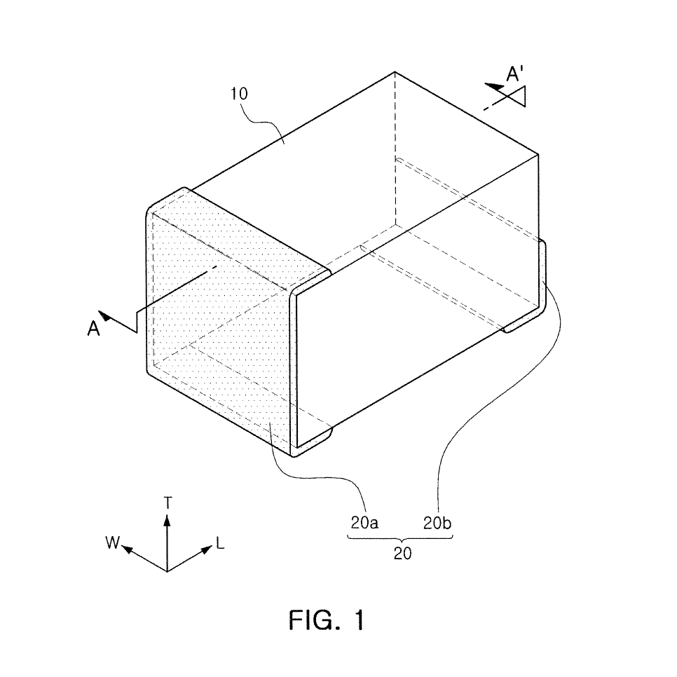

FIG. 1 is a perspective view of a chip coil component according to an exemplary embodiment of the present disclosure.

Referring to FIG. 1, the chip coil component according to an exemplary embodiment of the present disclosure may include a ceramic body 10 and an external electrode 20.

In this case, the external electrode 20 may include first and second external electrodes 20a and 20b disposed on both end surfaces in a length direction of the ceramic body 10, by way of example.

Hereinafter, a case in which the external electrode 20 includes the first and second external electrodes 20a and 20b will be described by way of example.

The ceramic body 10 may be formed by stacking a plurality of ceramic layers. The ceramic body 10 may have a bottom surface provided as a mounting surface, a top surface opposing the bottom surface, two end surfaces in the length direction, and two side surfaces in a width direction.

The ceramic body 10 may have a hexahedral shape, but is not particularly limited. Directions of a hexahedron will be defined in order to clearly describe an exemplary embodiment of the present disclosure. L, W and T shown in FIG. 1 refer to a length direction, a width direction, and a thickness direction, respectively. Here, the ‘thickness direction’ refers to a direction in which ceramic layers are stacked, that is, a ‘stacked direction’.

The plurality of ceramic layers, which are in a sintered state, may be integrated with each other so that a boundary between adjacent ceramic layers is not readily apparent without using a scanning electron microscope (SEM).

The plurality of ceramic layers may include dielectric and ferrite known in the art such as Mn-Zn based ferrite, Ni—Zn based ferrite, Ni—Zn—Cu based ferrite, Mn-Mg based ferrite, Ba based ferrite, Li based ferrite, or the like.

In addition, the ceramic body 10 may be formed by stacking and then sintering the plurality of ceramic layers.

A shape and a dimension of the ceramic body 10 and the number of stacked magnetic layers are not limited to those shown in the present exemplary embodiment.

Referring to FIG. 1, the first external electrode 20a may be disposed on one end surface of the ceramic body 10 in the length direction of the ceramic body 10 and the top surface and the bottom surface of the ceramic body 10. In addition, the second external electrode 20b may be disposed on the other end surface of the ceramic body 10 in the length direction of the ceramic body 10 and the bottom surface of the ceramic body 10.

More specifically, the first external electrode 20a may be formed to cover the entirety of one end surface of the ceramic body 10 in the length direction of the ceramic body 10. In addition, the first external electrode 20a may be formed to be extended from one end surface of the ceramic body 10 in the length direction of the ceramic body 10 to the top surface and the bottom surface of the ceramic body 10.

On the contrary, the second external electrode 20b may be formed to cover a portion of the other end surface of the ceramic body 10 in the length direction of the ceramic body 10. In addition, the second external electrode 20b may be formed to be extended from the other end surface of the ceramic body 10 in the length direction of the ceramic body 10 to the bottom surface of the ceramic body 10.

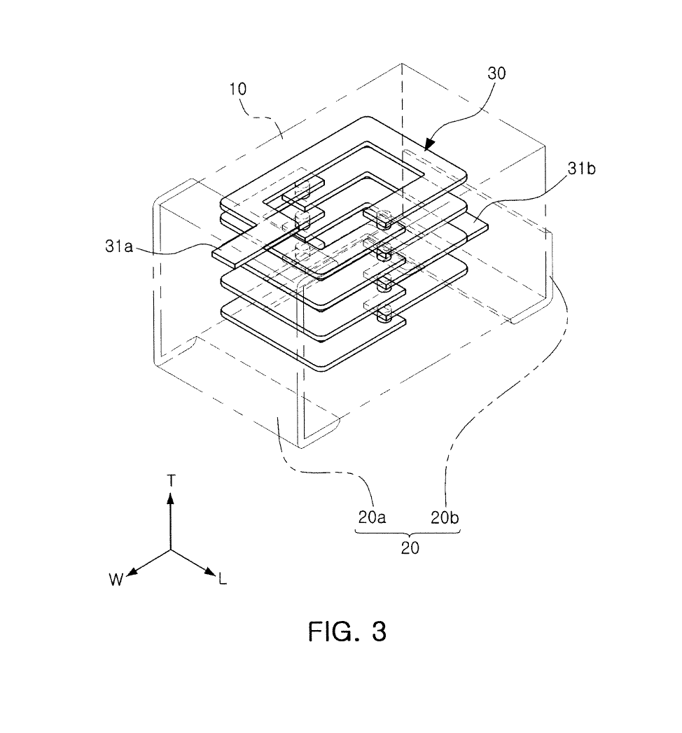

That is, the second external electrode 20b may not be formed on the top surface of the ceramic body 10, unlike the first external electrode 20a. A description thereof will be provided in detail with reference to FIG. 3.

The first and second external electrodes 20a and 20b may be formed by printing a conductive paste containing a conductive metal. The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

In addition, the first and second external electrodes 20a and 20b may be formed by applying and sintering conductive pastes prepared by adding glass frit to metal powder.

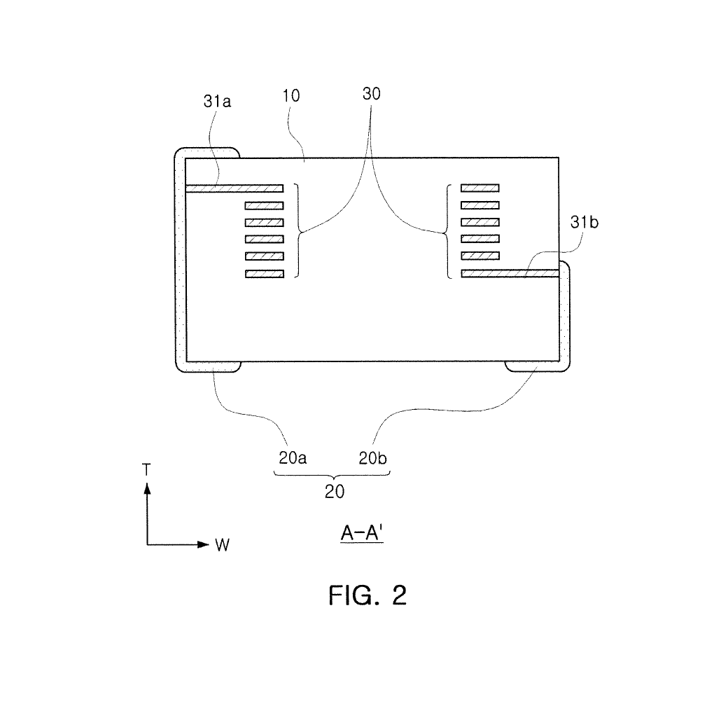

FIG. 2 is a cross-sectional view of the chip coil component shown in FIG. 1 taken along line A-A′.

FIG. 3 is a view showing an inner portion of a ceramic body in the chip coil component shown in FIG. 1.

Referring to FIGS. 2 and 3, the chip coil component according to an exemplary embodiment of the present disclosure may further include internal coil parts 30 including a plurality of internal coil patterns disposed to be connected to each other on the plurality of ceramic layers within the ceramic body 10.

The internal coil parts 30 may be formed by electrically connecting the plurality of internal coil patterns formed on the plurality of ceramic layers to each other by via electrodes. In this case, the via electrodes may be formed by a punching process in order to connect upper and lower ceramic layers to each other.

The plurality of internal coil patterns may be formed by printing a conductive paste containing a conductive metal. The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

The internal coil parts 30 may include first and second lead portions 31a and 31b exposed to both end surfaces of the ceramic body 10 in the length direction of the ceramic body 10.

The first external electrode 20a may be electrically connected to the first lead portion 31a and the second external electrode 20b may be electrically connected to the second lead portion 31b.

In this case, a length of a portion of the first external electrode 20a disposed on one end surface of the ceramic body 10 may be greater than a distance from the bottom surface of the ceramic body 10 to the first lead portion 31a. On the contrary, a length of a portion of the second external electrode 20b disposed on the other end surface of the ceramic body 10 may be less than a distance from the bottom surface of the ceramic body 10 to the first lead portion 31a.

Meanwhile, the length of the portion of the second external electrode 20b disposed on the other end surface of the ceramic body 10 may be greater than a distance from the bottom surface of the ceramic body 10 to the second lead portion 31b. That is, the length of the portion of the second external electrode 20b disposed on the other end surface of the ceramic body 10 may be greater than the distance from the bottom surface of the ceramic body 10 to the second lead portion 31b and be less than the distance from the bottom surface of the ceramic body 10 to the first lead portion 31a.

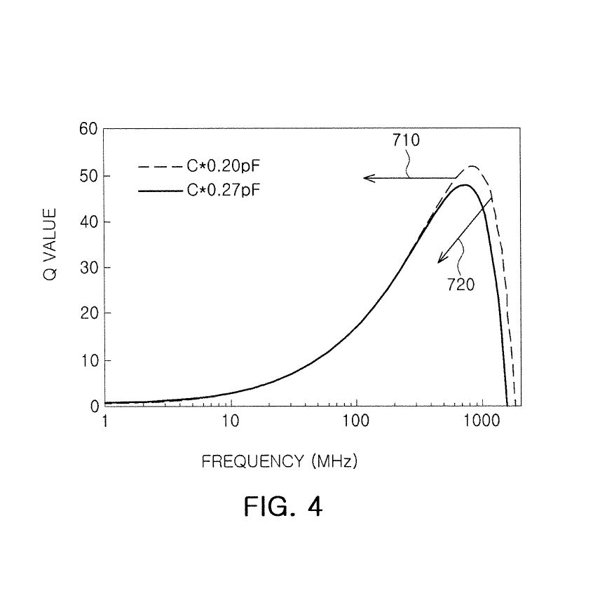

FIG. 4 is a graph showing changes in Q characteristics depending on an increase in parasitic components in a multilayer inductor according to the related art.

In this case, the multilayer inductor according to the related art refers to an inductor in which both the external electrodes formed on both end surfaces of the ceramic body in the length direction of the ceramic body are also formed on the top surface of the ceramic body.

In this case, the multilayer inductor according to the related art structurally has parasitic components C generated between the internal coil parts and the external electrodes. The higher the frequency, the larger the influence of the parasitic components. As a result, an LC resonance is caused, thereby moving a self resonance frequency (SRF) to a low frequency. In this case, the self resonance frequency refers to a resonance point by L and C and the characteristics of the inductor may be lost at the self resonance frequency or more.

That is, referring to FIG. 4, as the parasitic components C are increased, the self resonance frequency is moved to the low frequency. In this case, there is a problem that Q characteristics are not moved in a horizontal direction (710) while maintaining a Q waveform, but is moved to the low frequency (720) while Q characteristics are deteriorated in the vicinity of the self resonance frequency.

Therefore, the chip coil component according to an exemplary embodiment of the present disclosure may not form the second external electrode 20b on the top surface of the ceramic body 10 in order to significantly reduce the above-mentioned influence of parasitic components C, significantly increase inductance, and improve Q characteristics.

In this case, an area in which the internal coil pattern disposed in a direction of the second external electrode 20b among the internal coil parts 30 and the second external electrode 20b are overlapped is reduced, such that the generation of parasitic components C may be reduced as compared to the multilayer inductor according to the related art.

In addition, since the second external electrode 20b is not formed on the top surface of the ceramic body 10, a problem such as a short-circuit occurrence with a metal can covering an electronic component set or a malfunction of an electronic product, or the like may be reduced.

Further, since the external electrodes present on the top surface of the ceramic body 10 are significantly reduced, a problem such as space security, or the like at the time of mounting the product maybe solved and an effective area of the product may be increased.

In addition, since the second external electrode 20b made of the metal material is not formed on the top surface of the ceramic body 10, costs for producing the product may be reduced.

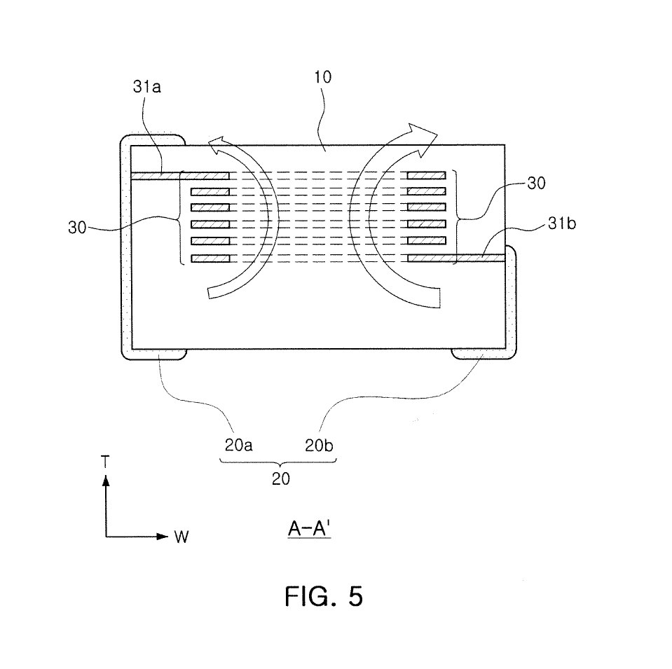

FIG. 5 is a view showing the flow of magnetic flux in the chip coil component according to an exemplary embodiment of the present disclosure.

Referring to FIG. 5, since the chip coil component according to an exemplary embodiment of the present disclosure does not have the second external electrode 20b formed on the top surface of the ceramic body 10, the flow of magnetic flux maybe smoothed, and consequently, a loss of magnetic flux may be reduced.

Meanwhile, although not shown, insulating layers may be further formed on region in which the first and second external electrodes 20a and 20b are not formed, among outer surfaces of the ceramic body 10.

By forming the insulating layers, contamination of the ceramic body 10 may be prevented from external moisture, foreign material, and the like.

In this case, the insulating layers may be formed by applying a material such as silicon, epoxy, or the like and may also be formed by coating glass.

In addition, the insulating layer may be formed on an overall surface of the ceramic body 10 and the first and second external electrodes 20a and 20b may also be formed on the insulating layer.

That is, after the insulating layer is formed to surround the overall surface of the sintered ceramic body 10, the first and second external electrodes 20a and 20b may be formed. In this case, the first and second lead portions 31a and 31b of the internal coil parts 30 may be electrically connected to the first and second external electrodes 20a and 20b, respectively.

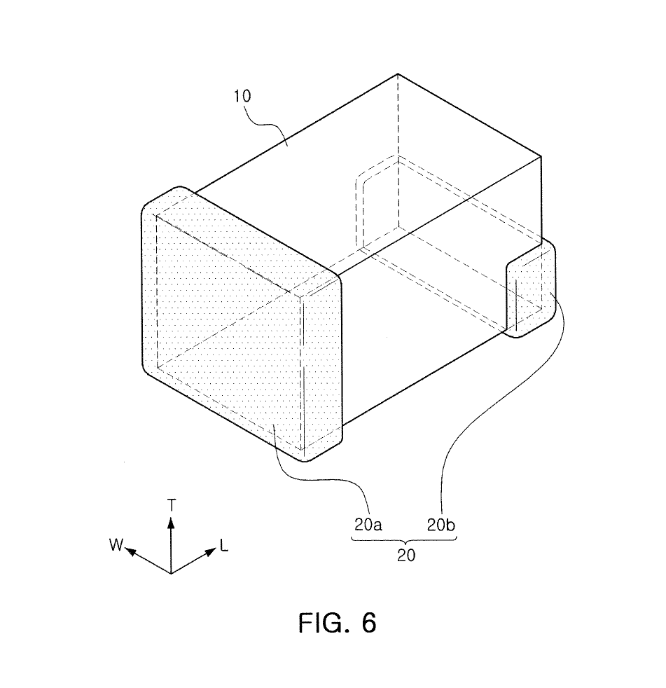

FIG. 6 is a perspective view of a chip coil component according to another exemplary embodiment of the present disclosure.

Referring to FIG. 6, the first and second external electrodes 20a and 20b may be further formed on both side surfaces of the ceramic body 10 in a width direction of the ceramic body 10.

Since the ceramic body 10 and the internal coil parts 30 except for the first and second external electrodes 20a and 20b are the same as those described above, a description thereof will be omitted.

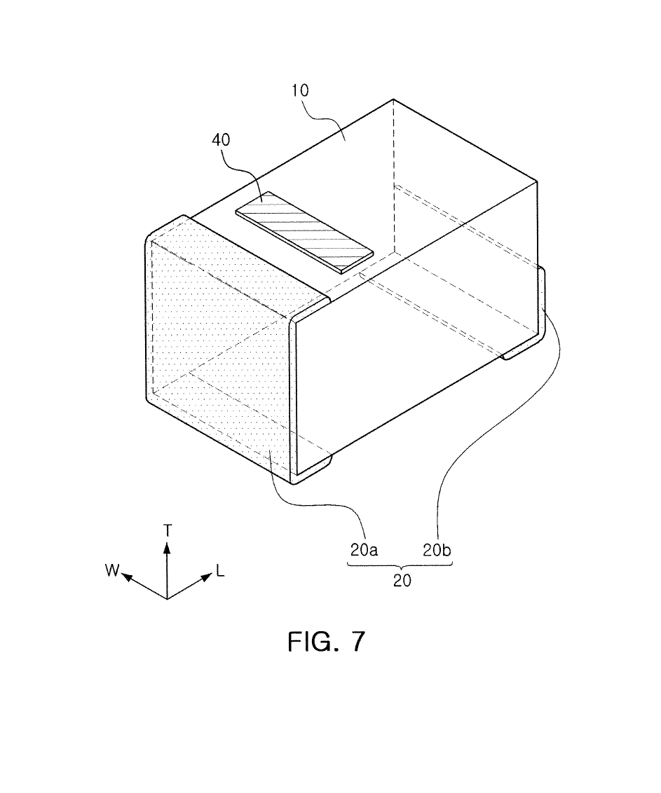

FIG. 7 is a view of a marking pattern 40 on the chip coil component shown in FIG. 1.

Referring to FIG. 7, the chip coil component according to an exemplary embodiment of the present disclosure may have the marking pattern 40 which is further formed on the top surface of the ceramic body 10 in order to identify surfaces to which the first and second lead portions 31a and 31b electrically connected to the first and second external electrodes 20a and 20b are exposed.

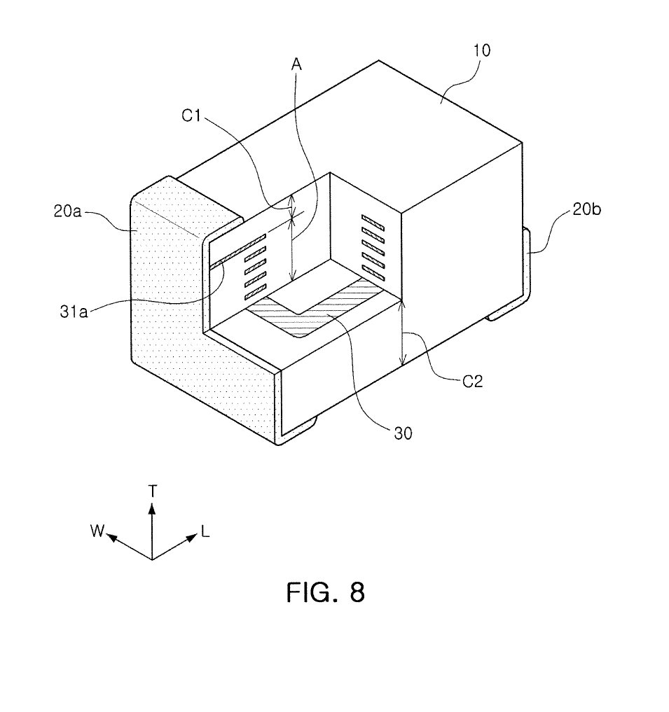

FIG. 8 is a view illustrating an active part A and cover parts C1 and C2 of the ceramic body in the chip coil component shown in FIG. 1.

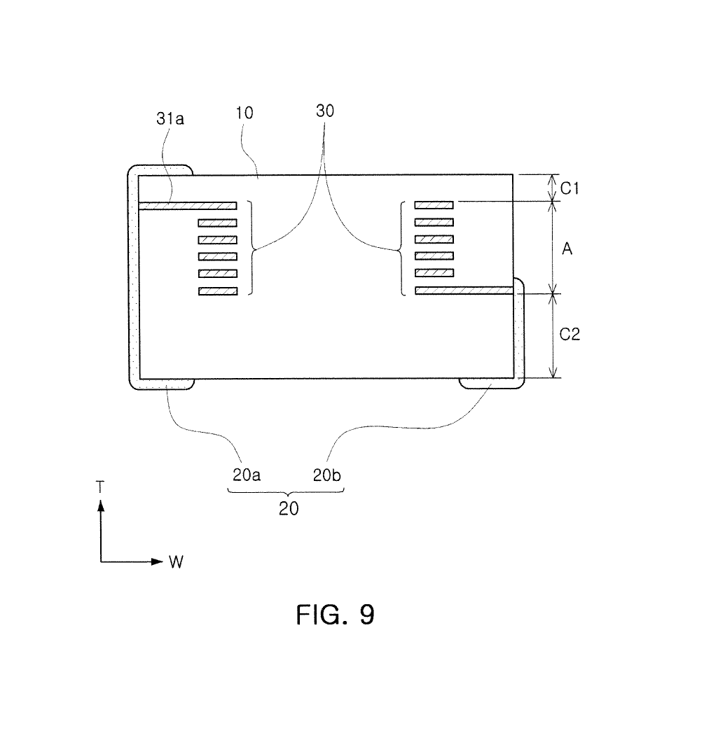

FIG. 9 is a cross-sectional view of the chip coil component shown in FIG. 8.

Referring to FIGS. 8 and 9, the ceramic body 10 may include an active part A, which is a capacitance forming part, a first cover part C1 disposed over the active part A in a thickness direction of the ceramic body 10, and a second cover part C2 disposed below the active part A in the thickness direction of the ceramic body 10.

The first and second cover parts C1 and C2 may be formed by sintering the plurality of ceramic layers, similar to the active part A. In addition, the plurality of ceramic layers including the first and second cover parts C1 and C2, which are in a sintered state, may be integrated with each other so that boundaries between adjacent ceramic layers are not readily apparent without using a scanning electron microscope (SEM), similar to the active part A.

In the chip coil component according to an exemplary embodiment of the present disclosure, the first cover part C1 may be thinner than the second cover part C2.

In this case, a ratio of a thickness of the first cover part C1 and a thickness of the second cover part C2 maybe 1:3.

Therefore, the internal coil parts 30 maybe formed to be close to the top surface of the ceramic body 10 on the basis of the thickness direction of the ceramic body 10.

Therefore, the chip coil component according to the present disclosure may prevent deterioration of inductance L or Q characteristics by an eddy current.

A case in which the chip coil component according to the present disclosure is mounted on a printed circuit board will be described, by way of example.

In this case, in the multilayer inductor according to the related art, the eddy current may occur between the internal coil parts and the printed circuit board. This is a phenomenon of the printed circuit board itself due to reaction against a leakage current flowing from the chip coil component and may be regarded as a kind of law of inertia.

That is, this may correspond to resistance which is emerged to maintain a current state for itself and this influence may disturb the flow of magnetic flux, thereby deteriorating inductance L and Q characteristics of the multilayer inductor. Further, an occurrence frequency of this phenomenon and a degree thereof maybe increased as a distance between the internal coil parts and the printed circuit board is closer to each other.

Therefore, referring to FIGS. 8 and 9, the chip coil component according to the present disclosure may have the second cover part C2 which is thicker than the first cover part C1 in order to significantly reduce the influence of the eddy current. That is, the internal coil parts 30 may be formed to be close to the top surface of the ceramic body 10 on the basis of the thickness direction of the ceramic body 10.

Thereby, deterioration of inductance L and Q characteristics of the chip coil component according to the present disclosure may be prevented.

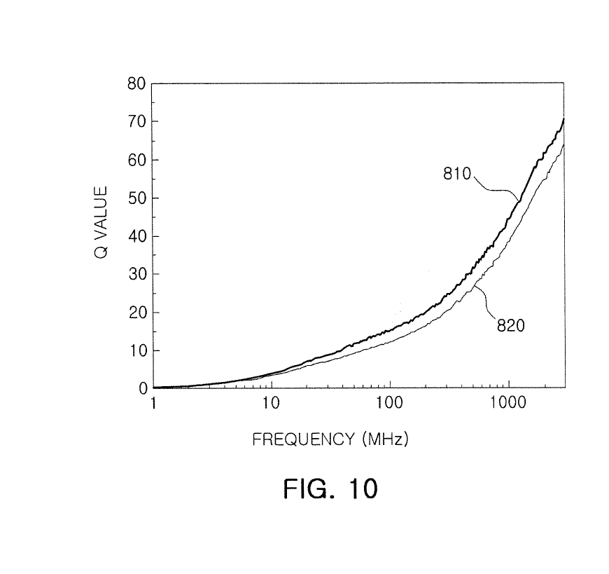

FIG. 10 is a graph illustrating comparison results between Q characteristics of a chip coil component according to an exemplary embodiment of the present disclosure and Q characteristics of a multilayer inductor according to the related art.

Referring to FIG. 10, it may be appreciated that a case 810 of the chip coil component according to an exemplary embodiment of the present disclosure has Q characteristics higher than that of a case 820 of the multilayer inductor according to the related art. Particularly, it may be appreciated that as the frequency band is increased, the Q characteristics may be improved.

As set forth above, according to exemplary embodiments of the present disclosure, since one of the external electrodes disposed on both end surfaces in the length direction of the ceramic body is not applied onto the upper surface of the ceramic body, the chip coil component may reduce the parasitic component C and may reduce the loss of magnetic flux.

In addition, the inductance L and the Q characteristic may be improved.

While exemplary embodiments have been shown and described above, it will be apparent to those skilled in the art that modifications and variations could be made without departing from the scope of the present invention as defined by the appended claims.

What is claimed is:

1. A chip coil component comprising:
a ceramic body in which a plurality of ceramic layers are disposed and of which a bottom surface is provided as a mounting surface;
a first external electrode disposed on one end surface of the ceramic body in a length direction of the ceramic body and a top surface and the bottom surface of the ceramic body; and
a second external electrode disposed on the other end surface of the ceramic body in the length direction of the ceramic body and the bottom surface of the ceramic body.

2. The chip coil component of claim 1, wherein the first and second external electrodes are further disposed on both side surfaces of the ceramic body in a width direction of the ceramic body.

3. The chip coil component of claim 1, further comprising internal coil parts including a plurality internal coil patterns disposed to be connected to each other on the plurality of ceramic layers within the ceramic body,
wherein the internal coil parts are connected to the first and second external electrodes.

4. The chip coil component of claim 3, wherein a length of a portion of the the second external electrode disposed on the other surface of the ceramic body is less than a distance from the bottom surface of the ceramic body to an uppermost internal coil pattern.

5. The chip coil component of claim 1, wherein the ceramic body includes:
an active part, a capacitance forming part; and
first and second cover parts disposed above and below the active part in a thickness direction of the ceramic body, and
the second cover part is thicker than the first cover part.

6. The chip coil component of claim 5, wherein a ratio of a thickness of the first cover part and a thickness of the second cover part is 1:3.

7. The chip coil component of claim 1, further comprising a marking pattern disposed on the top surface of the ceramic body.

8. A chip coil component comprising:
a ceramic body in which a plurality of ceramic layers are disposed and of which a bottom surface is provided as a mounting surface;
internal coil parts including a plurality of internal coil patterns disposed to be connected to each other on the plurality of ceramic layers within the ceramic body; and
first and second external electrodes disposed on both end surfaces of the ceramic body in a length direction of the ceramic body,
wherein the plurality of internal coil patterns include first and second lead portions exposed to the end surfaces of the ceramic body in the length direction of the ceramic body and connected to the first and second external electrodes, respectively,
a length of a portion of the first external electrode disposed on one end surface of the ceramic body is greater than a distance from the bottom surface of the ceramic body to the first lead portion, and
a length of a portion of the second external electrode disposed on the other end surface of the ceramic body is less than a distance from the bottom surface of the ceramic body to the second lead portion.

9. The chip coil component of claim 8, wherein the first and second external electrodes are further disposed on both side surfaces of the ceramic body in a width direction of the ceramic body.

10. The chip coil component of claim 8, wherein the ceramic body includes:
an active part, a capacitance forming part; and
first and second cover parts disposed above and below the active part in a thickness direction of the ceramic body, and
the second cover part is thicker than the first cover part.

11. The chip coil component of claim 10, wherein a ratio of a thickness of the first cover part and a thickness of the second cover part is 1:3.

12. The chip coil component of claim 8, further comprising a marking pattern disposed on the top surface of the ceramic body.
